(19) United States
(12) Patent Application Publication
(10) Pub. No.: US 2018/0281982 A1
(43) Pub. Date: Oct. 4, 2018

(54) DEGRADED OPERATING MODE FOR AN AIRCRAFT PROPULSION ASSEMBLY ENABLING REMOVAL OF A CAP TO A THRUST SETTING

(71) Applicant: Airbus Operations S.A.S., Toulouse (FR)

(72) Inventors: Patrick Zaccaria, Grisolles (FR); Sébastien Tranchard, Pibrac (FR)

(73) Assignee: Airbus Operations S.A.S., Toulouse (FR)

(21) Appl. No.: 15/938,014

(22) Filed: Mar. 28, 2018

(30) Foreign Application Priority Data
Mar. 29, 2017 (FR) 1752622

(51) Int. Cl. B64D 31/06

(52) U.S. Cl. CPC B64D 31/06; B64D 2045/0085

(57) ABSTRACT

A method and a device for controlling an aircraft propulsion assembly which mitigates the drawbacks of the application of a protection mode in which the maximum thrust is reduced (a degraded operating mode), in particular when an emergency situation occurs or the switch to protection mode is due to an incorrect analysis of the operating parameters of the propulsion assembly. The method includes a sequence of positions of the thrust control consisting in bringing the thrust control to idle then to setting it into the position corresponding to the desired thrust or a setting of the control to the maximum thrust position. Other simple sequences may include, the transition through the idling position with a transition to maximum thrust position, or through a succession of positions relative to the current position of the thrust control at the moment of the switch to degraded mode.

### FIELD OF THE INVENTION

The present invention relates to the field of the control of aircraft propulsion assemblies. It relates in particular to the control of the thrust from an aircraft propulsion assembly.

### BACKGROUND OF THE INVENTION

Aircraft, in particular the commercial aircraft comprising several propulsion assemblies, are generally equipped with devices that make it possible to monitor the operation of their propulsion assemblies and adapt the operation thereof in the event of an anomaly or failure.

Each engine, or more generally each propulsion assembly, of an aircraft is controlled by a dedicated controller. The controller generates and applies to the propulsion assembly a setting according to the desired thrust. This controller, often referred to by its acronym EEC, for “Engine Electronic Controller”, is connected to a set of sensors. These sensors are installed in different zones and/or are linked with different functions of the engine in order to measure operating parameters thereof.

The controller of an aircraft propulsion assembly also generally serves to protect the propulsion assembly in the event of an anomaly in its operation or of a failure.

The controller is generally configured, both from a hardware point of view and in software terms, to implement propulsion assembly protection measures when necessary. For example, if one (or more) of the operating parameters measured by the network of sensors to which the controller is linked or determined as a function of the measurements of these sensors, departs from a range considered normal in the operation of the engine, the controller can implement protection measures.

A first level of protection of the propulsion assembly may consist in having it operating a degraded operating mode. For example, in this degraded operating mode, the thrust generated by the propulsion assembly is limited relative to the maximum thrust in nominal operation (that is to say outside of the protection measures). Thus, in degraded operating mode, the setting generated by the controller is capped such that the thrust does not exceed a certain threshold.

Such a degraded operating mode does however present the drawback of preventing a thrust higher than the set threshold from being obtained, even in cases of emergency, and even if the application of the degraded operating mode originates from a false measurement or an incorrect interpretation of the controller. Obviously, a control allows the pilot of the aircraft to manually deactivate the degraded operating mode. Nevertheless, a solution allowing his or her mental load and all the actions ancillary to his or her main piloting task in an emergency situation to be limited to the maximum would be desirable.

### BRIEF SUMMARY OF THE INVENTION

The invention relates to a method of controlling an aircraft propulsion assembly in which the thrust generated by the propulsion assembly is governed by a controller generating a thrust setting applied to the propulsion assembly according to the position of a thrust control. The controller has:
a nominal operating mode in which the position of the thrust control directly determines the thrust setting applied to the propulsion assembly, and
at least one degraded operating mode, in which the thrust setting is capped such that the thrust from the propulsion assembly is limited to a predefined threshold which is lower than the maximum thrust in the nominal operating mode.

In the degraded operating mode, the performance of a predetermined sequence of positions of the thrust control authorizes the generation and the application of a thrust setting corresponding to a higher thrust than said predefined threshold.

By authorizing the control to generate a thrust setting that is uncapped relative to the setting corresponding to the thrust threshold predefined for the degraded operating mode by a predetermined sequence of the thrust control, the invention allows the pilot to recover a thrust increase from the engine, at least temporarily, for example in response to an emergency situation in which the absolute protection of the engine is no longer the first priority.

Preferably, the predetermined sequence is simple and intuitive, while translating with certainty the will of the pilot to obtain more thrust.

The predetermined sequence can comprise the setting of the control into a position corresponding to the desired thrust, the thrust setting then generated corresponding to said desired thrust.

According to one embodiment, the predetermined sequence comprises the setting of the thrust control into a predefined position of idling of the propulsion assembly followed by the setting of the control into a position corresponding to the desired thrust.

According to another embodiment, the predetermined sequence comprises the setting of the thrust control into a position corresponding to the maximum thrust.

In the degraded operating mode and subsequent to the predetermined sequence of positions of the thrust control, the thrust can be limited to its current value such that the thrust setting is not increased if the thrust control is maneuvered again into a position corresponding to a higher thrust than said current value.

In the degraded operating mode and subsequent to the predetermined sequence of positions of the thrust control, the maneuvering of the thrust control into a position corresponding to a lower thrust than the current thrust can lead to the generation of a thrust setting corresponding to the position of the control.

In the degraded operating mode and subsequent to the predetermined sequence of positions of the thrust control, the number of performances of the predetermined sequence is counted and any subsequent maneuver of the thrust control corresponding to a thrust request above the threshold is rendered inoperative if a given number of performances of the predetermined sequence is exceeded.

The given number of performances of the predetermined sequence can for example be one, two, three or four.

The invention relates also to a device for controlling the thrust generated by an aircraft propulsion assembly comprising a thrust control whose position corresponds to a desired thrust and a controller suitable for generating a thrust setting and for transmitting it to a propulsion assembly, in which the controller is configured so as to have: a nominal operating mode and at least one degraded operating mode, and in which, in the nominal operating mode, the position of the thrust control directly determines a thrust setting generated by the controller, and in the degraded operating mode, the thrust setting is limited to a predefined threshold which is lower than the setting corresponding to the maximum thrust in the nominal operating mode. The controller is also configured such that, in the degraded operating mode, a predetermined sequence of positions of the thrust control authorizes the generation of a thrust setting corresponding to a higher thrust than said predefined threshold.

The invention relates finally to an aircraft comprising at least one propulsion assembly and one such control device for controlling the thrust generated by said propulsion assembly.

Other particular features and advantages of the invention will become more apparent from the following description.

### BRIEF DESCRIPTION OF THE DRAWINGS

In the attached drawings, given by way of nonlimiting examples:

FIG. 1 represents a schematic perspective view of an aircraft comprising a device according to an embodiment of the invention;

FIG. 2 schematically represents the steps of a method implemented in an embodiment of the invention.

### DETAILED DESCRIPTION

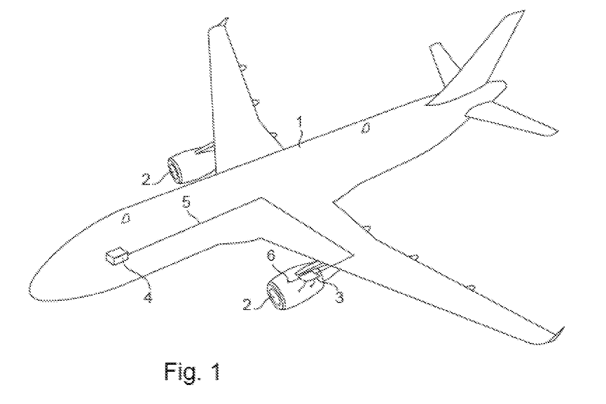

FIG. 1 schematically presents an aircraft 1 comprising two propulsion assemblies 2. The invention is described hereinbelow in relation to a propulsion assembly 2, but it applies quite obviously advantageously to each propulsion assembly 2 of the aircraft concerned.

The propulsion assembly 2 is equipped with a controller 3 which governs said propulsion assembly 2. Thus, the controller 3 is responsible for generating control signals intended for the propulsion assembly, in order to drive the operating thereof. In particular, the controller 3 transmits a thrust setting, which indicates to the propulsion assembly the thrust or the power that it must produce.

In a nominal operating mode of the controller 3, which is its normal operating mode and the one generally implemented by the controller, the thrust setting is directly linked to the position of a thrust control 4. The thrust control 4, also called “throttle”, generally comprises a stick that can be actuated by the pilot of the aircraft, and whose rotational or translational position corresponds to a power or thrust value desired for the propulsion assembly 2 associated with this thrust control 4. In other words, in nominal operating mode of the controller 3, the position of the thrust control 4 corresponds to a desired thrust, this position is transmitted to the controller 3 by a control link 5, and the controller 3 generates a thrust setting corresponding to the desired thrust and transmits it to the propulsion assembly 2, which applies this setting and produces the corresponding thrust.

The controller 3 also collects information from sensors 6, that can be organized in a network. The sensors 6 allow the measurement, or the determination, of operating parameters of the propulsion assembly 2. The operating parameters comprise, for example, the temperature measured at one or more points of the propulsion assembly, the pressure measured at one or more points, the speed of rotation, the fuel flow rate, the oil pressure. Many other parameters are also generally monitored.

The monitoring and the tracking of the parameters allow the controller to determine an anomaly in the operation of the propulsion assembly 2, even a failure of the propulsion assembly 2. To this end, each parameter can be associated with a range of values within which it is considered normal for said parameter to be situated in the operation of the propulsion assembly. When a parameter departs from the range with which it is associated, the controller 3 can, if necessary, conclude on an operating anomaly of the propulsion assembly 2.

In order to preserve the integrity of the propulsion assembly 2 or, more generally, avoid the propagation of a failure to several elements of the propulsion assembly 2 or of the aircraft 1, the controller 3 can order the implementation of protection measures. For example, two levels of protection measures (or protection modes) can be envisaged. One protection mode can consist, in the most critical cases, in ordering the complete shutdown of the engine. In cases of lower criticality, a protection mode may consist in having the controller 3, and therefore the propulsion assembly 2, operate according to a degraded operating mode. For example, in the degraded operating mode, the maximum thrust that the propulsion assembly 2 can provide can be limited to a fraction of the maximum thrust in nominal mode. For example, the thrust in degraded mode can be limited to a value lying between 40% and 90% of the maximum thrust in nominal operating mode. This limitation is governed by the controller 3, for example by capping the thrust setting in degraded mode (that is to say by prohibiting the generation and the transmission of a setting corresponding to a higher thrust than a predefined threshold).

The thrust of one or more of the other propulsion assemblies 2 of the aircraft 1 can if necessary be adapted in response to this limitation.

Nevertheless, some emergency situations may require an increase in thrust, at least temporarily, beyond the threshold predefined for the degraded operating mode.

For that, the pilot of the aircraft 1 generally has the possibility of manually deactivating the degraded mode. However, that requires an additional or non-intuitive action on his or her part, in a potentially emergency situation.

Furthermore, in the event of incorrect triggering of the degraded mode, the return to the nominal mode requires a reinitialization of the controller, which can take too long to respond to an emergency situation.

It is thus proposed, in the invention, when the controller 3 is in degraded operating mode, to allow, despite everything, a higher thrust than the predefined threshold to be obtained following the performance by the pilot of a predetermined sequence of positions of the thrust control.

For maximum benefit from the invention, the predetermined sequence is advantageously simple, intuitive, while certainly translating the will of the pilot to obtain an additional thrust despite the operation in degraded mode.

For example, the predetermined sequence can consist of a setting of the thrust control (throttle) into the position corresponding to the idling of the engine (an action that the pilots are used to because the degraded mode generally requires a return of the throttle to the idling position), followed by a setting of the throttle into the position corresponding to the desired thrust.

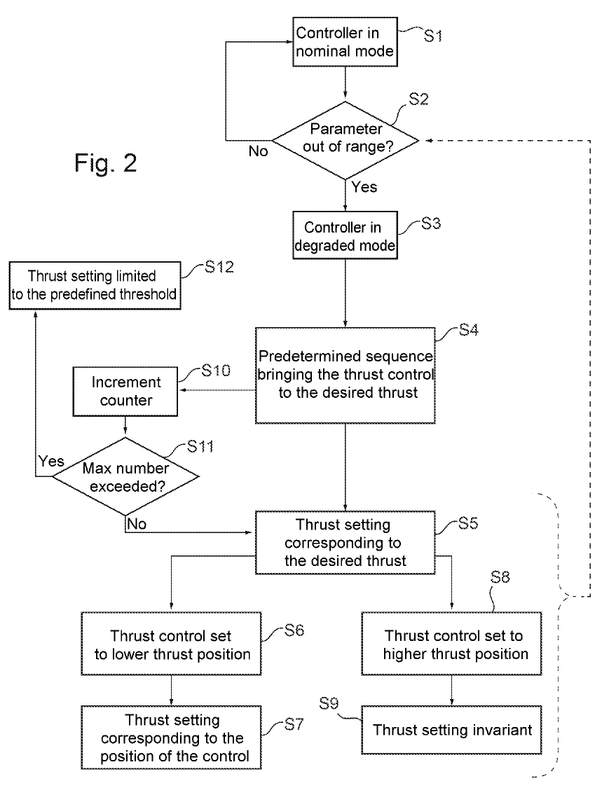

An example of a method employing this sequence and that can be implemented in the invention is detailed with respect to FIG. 2.

In a first step S1, a controller of an aircraft propulsion assembly operates according to its nominal operating mode. The thrust setting that it generates corresponds to the thrust associated with the current position of the thrust control.

In a step S2, the controller determines, according to the signals that it receives from sensors and continuously, whether an operating parameter of the propulsion assembly departs from the range considered normal which is associated with it. As long as no anomaly is detected, in particular as long as no operating parameter departs from the range which is assigned to it, the controller remains in its nominal operating mode.

In case of anomaly, reflected in the example represented here by a departure of (at least) one operating parameter from the range which is associated with it, the controller switches to degraded operating mode in a step S3.

If the pilot wants to obtain an increase in thrust despite the switch to degraded mode, he or she performs one with the thrust control a predetermined sequence, which is certainly intended, and comminuting in setting the control into a position corresponding to the desired thrust (step S4).

The performance of the predetermined sequence translates with certainty the will of the pilot to obtain a thrust potentially higher than the thrust threshold predefined for the degraded mode. As examples, the predetermined sequence can comprise:
the setting of the thrust control into a position corresponding to the idling speed of the propulsion assembly followed by the setting of the thrust control into a position corresponding to the desired thrust; or
the setting of the thrust control into a position corresponding to the maximum thrust (called “full throttle”). In this case, the desired thrust is the maximum thrust, or, if the thrust control is brought into another position following the switch to full throttle, the thrust corresponding to this other position.

Other predefined sequences definitely translating the will of the pilot can be envisaged.

The controller generates a thrust setting corresponding to the desired thrust and applies it in a step S5 to the propulsion assembly, which thus produces the desired thrust despite the fact that the controller is still in degraded operating mode.

In the example represented here by way of example, the position applied next to the thrust control is then considered.

According to a first particular case, the thrust control is set into a position corresponding to a lower thrust than the current thrust (step S6). In this case, the thrust is reduced accordingly by generation and application of a corresponding thrust setting (step S7).

According to a second particular case, the thrust control is set into a position corresponding to a higher thrust than the current thrust (step S8). With the controller still operating according to the degraded mode, this new movement of the thrust control is not reflected by an increase in the thrust setting and consequently in the thrust. The thrust therefore remains invariant (step S9).

The third particular case corresponds to a new execution of the predetermined sequence (return to the step S4).

Nevertheless, provision can be made in the method implemented (as in the method here represented by way of example) to limit the possibility of obtaining a thrust increase beyond the predefined threshold to a single occurrence, or to a given number of occurrences. For that, each time the predetermined sequence of the thrust control is performed when the controller is in degraded mode, a counter is incremented (S10). In a step S11, the controller assesses whether the given number of occurrences (for example one) is exceeded. If the given number is exceeded, then the controller applies the degraded mode without exception (step S12), that is to say that the thrust setting is capped such that the thrust is limited to the threshold predefined for the degraded mode, and even if the thrust control setting to a position corresponding to a higher thrust. If the given number is not exceeded, then the controller authorizes, in the step S5, the generation of a thrust setting corresponding to the desired thrust corresponding to the position of the thrust control.

Obviously, throughout this procedure, the controller can check whether a return to operation according to the nominal mode can be performed. This entails, on the one hand, checking that the operating parameters of the propulsion assembly are once again within their respective allowable range, but also checking that the reinitialization of the controller can be performed safely.

Furthermore, at any moment, the controller can assess whether, in particular because of the required thrust increase, a return to the degraded mode without thrust increase authorization or even the application of another protection measure (such as shutting down of the propulsion assembly) must be ordered.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method of controlling an aircraft propulsion assembly in which the thrust generated by the propulsion assembly is governed by a controller generating a thrust setting applied to the propulsion assembly according to the position of a thrust control, said controller having:
a nominal operating mode in which the position of the thrust control directly determines the thrust setting applied to the propulsion assembly, and
at least one degraded operating mode, in which the thrust setting is capped such that the thrust from the propulsion assembly is limited to a predefined threshold which is lower than the maximum thrust in the nominal operating mode,
wherein, in the degraded operating mode, the performance of a predetermined sequence of positions of the thrust control authorizes a generation and an application of a thrust setting corresponding to a higher thrust than said predefined threshold.

2. The method according to claim 1, in which the predetermined sequence comprises setting of the thrust control in a position corresponding to the desired thrust, a thrust setting then generated corresponding to said desired thrust.

3. The method according to claim 2, in which the predetermined sequence comprises setting of the thrust control into a predefined position of idling of the propulsion assembly followed by setting of the thrust control into a position corresponding to the desired thrust.

4. The method according to claim 2, in which the predetermined sequence comprises setting of the thrust control into a position corresponding to the maximum thrust.

5. The method according to claim 1, in which, in the degraded operating mode and subsequent to the predetermined sequence of positions of the thrust control, the thrust is limited to its current value such that the thrust setting is not increased if the thrust control is maneuvered again into a position corresponding to a higher thrust than said current value.

6. The method according to claim 1, in which, in the degraded operating mode and subsequent to the predetermined sequence of positions of the thrust control, maneuvering of the thrust control into a position corresponding to a lower thrust than the current thrust leads to the generation of a thrust setting corresponding to the position of the control.

7. The Method according to claim 1, in which, in the degraded operating mode and subsequent to the predetermined sequence of positions of the thrust control, a number of performances of the predetermined sequence is counted and any subsequent maneuver of the thrust control corresponding to a thrust request above the threshold is rendered inoperative if a given number of performances of the predetermined sequence is exceeded.

8. The method according to claim 7, in which the given number of performances of the predetermined sequence is one, two, three or four.

9. A device for controlling the thrust generated by an aircraft propulsion assembly comprising:
a thrust control whose position corresponds to a desired thrust; and
a controller configured for generating a thrust setting and for transmitting the thrust setting to a propulsion assembly;
wherein the controller is configured to have: a nominal operating mode and at least one degraded operating mode,
and wherein:
in the nominal operating mode, a position of the thrust control directly determines a thrust setting generated by the controller, and
in the degraded operating mode, the thrust setting is limited to a predefined threshold which is lower than a setting corresponding to the maximum thrust in the nominal operating mode,
wherein the controller is also configured such that, in the degraded operating mode, a predetermined sequence of positions of the thrust control authorizes the generation of a thrust setting corresponding to a higher thrust than said predefined threshold.

10. An aircraft comprising at least one propulsion assembly and a control device according to claim 9 for controlling the thrust generated by said propulsion assembly.
